(19) United States
(12) Patent Application Publication
(10) Pub. No.: US 2022/0416295 A1
(43) Pub. Date: Dec. 29, 2022

(54) HALIDE-BASED NANOCOMPOSITE, SOLID ELECTROLYTE COMPRISING SAME, MANUFACTURING METHOD THEREOF, AND ALL-SOLID-STATE BATTERY COMPRISING SOLID ELECTROLYTE

(71) Applicant: INDUSTRY-ACADEMIC COOPERATION FOUNDATION, YONSEI UNIVERSITY, Seoul (KR)

(72) Inventors: Yoon Seok JUNG, Seoul (KR); Hiram Kwak, Seoul (KR)

(73) Assignee: INDUSTRY-ACADEMIC COOPERATION FOUNDATION, YONSEI UNIVERSITY, Seoul (KR)

(21) Appl. No.: 17/842,446

(22) Filed: Jun. 16, 2022

(30) Foreign Application Priority Data
Jun. 18, 2021 (KR) 10-2021-0079492
May 10, 2022 (KR) 10-2022-0057343

(51) Int. Cl. H01M 10/0562; H01M 10/0525; C01G 25/04

(52) U.S. Cl. CPC H01M 10/0562; H01M 10/0525; C01G 25/04; H01M 2300/008; H01M 2250/20; C01P 2006/40; C01P 2004/04; C01P 2002/72; C01P 2002/01

(57) ABSTRACT

The present disclosure relates to a solid electrolyte containing a halide-based nanocomposite, a method for preparing the same and an all-solid-state battery including the solid electrolyte. Halide-based nanocomposites were prepared by the mechanochemical reaction of a lithium oxide precursor, a lithium halide precursor, and a metal halide in order to improve the low ion conductivity and large interfacial resistance of the existing halide-based solid electrolyte. Furthermore, it is possible to provide superior atmospheric stability, improve ion conductivity through activation of interfacial conduction and, at the same time, significantly improve the interfacial stability with a sulfide-based solid electrolyte and high-voltage cycle stability.

### CROSS-REFERENCE TO RELATED APPLICATION

This application claims priority to Korean Patent Application Nos. 10-2021-0079492 and 10-2022-0057343, filed on Jun. 18, 2021 and May 10, 2022, respectively, and all the benefits accruing therefrom under 35 U.S.C. § 119, the contents of which in its entirety are herein incorporated by reference.

### BACKGROUND

### 1. Field

The present disclosure relates to a halide-based nanocomposite, a solid electrolyte containing the same, a method for preparing the same, and an all-solid-state battery including the solid electrolyte.

### 2. Description of the Related Art

Recently, the industrial sectors requiring lithium-ion batteries are expanding from small-sized power supplies for mobile devices to medium- and large-sized power supplies of electric vehicles (EVs), hybrid electric vehicles (HEVs) and energy storage systems (ESSs). In particular, interests in the eco-friendly electric vehicles are increasing greatly, and the world's major automakers are spurring to develop eco-friendly electric vehicles for the next generation. For medium- and large-sized lithium-ion batteries, safety is essential because of harsh operation environments such as temperature and impact and use of a large number of batteries, unlike small-sized lithium-ion batteries. Therefore, as the application of lithium-ion batteries expands toward large-sized batteries, the interests in the safety issue of lithium-ion batteries are increasing significantly.

The existing lithium-ion batteries have such problems as low thermal stability, flammability, leakage, etc. due to the use of organic liquid electrolytes. Actually, explosions of products using them have been reported consistently and it is urgently needed to solve the problem. An all-solid-state battery using a solid electrolyte is emerging as a possible solution.

For the all-solid-state battery to exert its performance, it should have superior contact characteristics between solid electrolyte and active material particles. In this regard, a sulfide-based solid electrolyte is advantageous in that an all-solid-state battery with superior lithium ion conductivity can be obtained because close contact between solid electrolyte and active material particles can be achieved only with cold pressing due to higher ductility as compared to an oxide-based solid electrolyte which is electrochemically superior but has hard mechanical property.

Although the sulfide-based solid electrolytes have the advantages of high ionic conductivities and deformability allowing for a simple cold-pressing fabrication of ASSB cells, it is very difficult to use them to prepare all-solid-state batteries due to low electrochemical stability and poor atmospheric stability as compared to the oxide-based solid electrolytes. In addition, the evolution of H₂S gas during the preparation process is also a risk factor. Various researches have been conducted on halide-based solid electrolytes to solve the above-described problems.

For example, Li₃YCl₆ and Li₃YBr₆ have been researched to improve the atmospheric and electrochemcial stability of the sulfide-based solid electrolytes. But, the use of the rare-earth-based materials for preparation of all-solid-state batteries still has the problem of toxicity or price. In addition, when they are used in the all-solid-state batteries together with sulfide solid electrolytes, side reactions may occur at high voltages between the sulfides and the halide-based solid electrolytes.

Furthermore, although the replacement of the central metal or anion is being studied to improve the ion conductivity of the halide solid electrolyte to a level comparable to that of the sulfide-based material, there is still a limitation in improving the ion conductivity.

### REFERENCES OF THE RELATED ART

### Patent Documents

(Patent document 1) Korean Patent Registration No. 10-1586536.

(Patent document 2) Korean Patent Publication No. 2011-0025661.

(Patent document 3) Japanese Patent Publication No. 2011-076792.

### SUMMARY

The present disclosure is directed to providing a halide-based nanocomposite for a solid electrolyte of a lithium-ion battery, which has superior ion conductivity and electrochemical oxidation stability.

The present disclosure is also directed to providing a positive electrode active material for a lithium-ion battery, which includes a positive electrode active material core and a halide-based nanocomposite shell.

The present disclosure is also directed to providing a solid electrolyte for a lithium-ion battery, which contains the halide-based nanocomposite described above and a sulfide or oxide-based solid electrolyte.

The present disclosure is also directed to providing a double-layer solid electrolyte for a lithium-ion battery, which contains the halide-based nanocomposite described above.

The present disclosure is also directed to providing an all-solid-state battery including the solid electrolyte described above.

The present disclosure is also directed to providing an all-solid-state battery including the double-layer solid electrolyte described above.

The present disclosure is also directed to providing a device including the all-solid-state battery described above.

The present disclosure is also directed to providing an electrical device including the all-solid-state battery described above.

The present disclosure is also directed to providing a method for preparing a halide-based nanocomposite for a solid electrolyte of a lithium-ion battery.

The present disclosure provides a halide-based nanocomposite for a solid electrolyte of a lithium-ion battery, which is represented by at least one of Chemical Formulas 1-3:

M1O_{c}—LiₐM1X_{b} [Chemical Formula 1]

(wherein M1 is one or more selected from a group consisting of Ti, Zr and Hf, X is Cl, Br, F or I, and each of a, b and c is independently a real number of 0.1-10)

LiX—LiₐM1X_{b} [Chemical Formula 2]

(wherein M1 is one or more selected from a group consisting of Ti, Zr and Hf, X is Cl, Br, F or I, and each of a, b and c is independently a real number of 0.1-10)

M1O_{c}—LiX—LiₐM1X_{b} [Chemical Formula 3]

(wherein M1 is one or more selected from a group consisting of Ti, Zr and Hf, X is Cl, Br, F or I, and each of a, b and c is independently a real number of 0.1-10).

The present disclosure also provides a positive electrode active material for a lithium-ion battery, which includes: a core including a positive electrode active material; and a shell surrounding the surface of the core and including the halide-based nanocomposite according to the present disclosure.

The present disclosure also provides a solid electrolyte for a lithium-ion battery, which contains the halide-based nanocomposite according to the present disclosure and a sulfide or oxide-based solid electrolyte.

The present disclosure also provides a double-layer solid electrolyte for a lithium-ion battery, which contains: a solid electrolyte for a positive electrode, which contains the halide-based nanocomposite according to the present disclosure; and a solid electrolyte for a negative electrode, which is formed on the solid electrolyte for a positive electrode and contains a sulfide or oxide-based solid electrolyte.

The present disclosure also provides an all-solid-state battery, which includes: a positive electrode; a negative electrode; and the solid electrolyte according to the present disclosure, which is disposed between the positive electrode and the negative electrode.

The present disclosure also provides an all-solid-state battery, which includes: a positive electrode; a negative electrode; and the solid electrolyte according to the present disclosure, which is disposed between the positive electrode and the negative electrode, wherein the positive electrode is positioned on the solid electrolyte for a positive electrode of the double-layer solid electrolyte, and the negative electrode is positioned on the solid electrolyte for a negative electrode.

The present disclosure also provides a device including the all-solid-state battery, wherein the device is one selected from a communication device, a transportation device and an energy storage device.

The present disclosure also provides an electrical device including the all-solid-state battery, wherein the electrical device is one selected from an electric vehicle, a hybrid electric vehicle, a plug-in hybrid electric vehicle and a power storage device.

The present disclosure also provides a method for preparing a halide-based nanocomposite for a solid electrolyte of a lithium-ion battery, which includes a step of preparing a halide-based nanocomposite represented by at least one of Chemical

Formulas 1-3 by mixing a lithium oxide precursor with a metal halide precursor in solid state under inert gas atmosphere:

M1O_{c}—LiₐM1X_{b} [Chemical Formula 1]

(wherein M1 is one or more selected from a group consisting of Ti, Zr and Hf, X is Cl, Br, F or I, and each of a, b and c is independently a real number of 0.1-10)

LiX—LiₐM1X_{b} [Chemical Formula 2]

(wherein M1 is one or more selected from a group consisting of Ti, Zr and Hf, X is Cl, Br, F or I, and each of a, b and c is independently a real number of 0.1-10)

M1O_{c}—LiX—LiₐM1X_{b} [Chemical Formula 3]

(wherein M1 is one or more selected from a group consisting of Ti, Zr and Hf, X is Cl, Br, F or I, and each of a, b and c is independently a real number of 0.1-10).

The halide-based nanocomposite of the present disclosure, which is formed from a lithium oxide precursor, a lithium halide precursor and a metal halide, has superior atmospheric stability. In addition, it may have improved ion conductivity due to activated interfacial conduction and, at the same time, remarkably improved interfacial stability with a sulfide-based solid electrolyte and high-voltage cycle stability.

The effects of the present disclosure are not limited to those mentioned above. It should be understood that all the effects that can be inferred from the following description are included as the effects of the present disclosure.

### BRIEF DESCRIPTION OF THE DRAWINGS

FIG. 1 shows the XRD analysis result of solid electrolytes containing halide-based nanocomposites prepared in Examples 1-4, 7 and 10 and Comparative Example 1.

FIG. 2 shows the ⁶Li MAS NMR analysis result of halide-based nanocomposites prepared in Comparative Example 1 (Li₂ZrCl₆), Comparative Example 2 (ZrO₂ (20 nm)-2Li₂ZrCl₆) and Example 1 (ZrO₂-2Li₂ZrCl₆).

FIG. 3 shows the TEM images of a halide-based nanocomposite prepared in Example 4.

FIG. 4 shows the TEM images of a 0.5ZrO₂—Li₂ZrCl₆ halide-based nanocomposite prepared in Comparative Example 1.

FIG. 5 shows the result of measuring ion conductivity for ZrO₂ particles grown in situ in a halide-based nanocomposite prepared in Example 4 and 20 nm-ZrO₂, 50 nm-MgO, fumed SiO₂ and 50 nm-Al₂O₃ particles mixed in existing halide-based nanocomposites.

FIG. 6 shows the voltage-capacity curves of all-solid-state batteries prepared using solid electrolytes of Example 1 and Comparative Example 1 for initial charge-discharge cycles.

FIG. 7 shows the discharge capacity curves of all-solid-state batteries prepared using solid electrolytes of Example 1 and Comparative Example 1 depending on cycle numbers.

### DETAILED DESCRIPTION

Hereinafter, the present disclosure is described more specifically through exemplary embodiments.

The present disclosure relates to a halide-based nanocomposite, a solid electrolyte containing the same, a method for preparing the same, and an all-solid-state battery including the solid electrolyte.

As described above, the existing lithium-ion batteries have stability issues related with frequent fires due to the use of flammable organic liquid electrolytes. Therefore, researches are being conducted to replace them with a halide-based solid electrolyte, which is a nonflammable inorganic solid electrolyte, to solve the stability problem and increase ion conductivity at the same time.

The present disclosure is advantageous in that, by forming a halide-based nanocomposite from a lithium oxide precursor, a lithium halide precursor and a metal halide to improve the low ion conductivity and large interfacial resistance of the existing halide-based solid electrolyte, superior atmospheric stability can be provided, ion conductivity can be improved through activation of interfacial conduction and, at the same time, the interfacial stability with a sulfide-based solid electrolyte and high-voltage cycle stability can be improved remarkably.

Specifically, the present disclosure provides a halide-based nanocomposite for a solid electrolyte of a lithium-ion battery, which is represented by at least one of

M1O_{c}—LiₐM1X_{b} [Chemical Formula 1]

(wherein M1 is one or more selected from a group consisting of Ti, Zr and Hf, X is Cl, Br, F or I, and each of a, b and c is independently a real number of 0.1-10)

LiX—LiₐM1X_{b} [Chemical Formula 2]

(wherein M1 is one or more selected from a group consisting of Ti, Zr and Hf, X is Cl, Br, F or I, and each of a, b and c is independently a real number of 0.1-10)

M1O_{c}—LiX—LiₐM1X_{b} [Chemical Formula 3]

(wherein M1 is one or more selected from a group consisting of Ti, Zr and Hf, X is Cl, Br, F or I, and each of a, b and c is independently a real number of 0.1-10).

Specifically, in Chemical Formulas 1-3, M1 is Zr or Ti, X is Cl or Br, and each of a, b and c is independently a real number from 0.1 to 5.

Most specifically, in Chemical Formulas 1-3, M1 is Zr, X is Cl, and each of a, b and c is independently a real number from 0.1 to 4.

The halide-based nanocomposite may be formed as the lithium oxide precursor reacts with the metal halide to form a nanocomposite including a halide solid electrolyte, a lithium halide and a metal oxide with a size of several nanometers, represented by Chemical Formulas 1-3.

The lithium halide and the metal oxide of the halide-based nanocomposite may form a halide-based nanocomposite with high ion conductivity by forming a space charge layer at the solid electrolyte interface. Since the lithium halide and the metal oxide can block the direct contact between the halide solid electrolyte and the sulfide-based solid electrolyte, side reactions occurring at the interface in high temperature and high voltage environments may be prevented and, furthermore, cycle stability may be improved at high voltages.

In Chemical Formula 1, the content of M1O_{c} may be 1-20 vol % and the content of LiₐM1X_{b} may be 80-99 vol %. Specifically, the content of M1O_{c} may be 6-9 vol % and the content of LiₐM1X_{b} may be 91-94 vol %. Most specifically, the content of M1O_{c} may be 7-8 vol % and the content of LiₐM1X_{b} may be 92-93 vol %. Particularly, if the content of M1O_{c} is below 7 vol %, a sufficient interfacial ion conductive phase cannot be formed. And, if it exceeds 8 vol %, the metal oxide lacking ion conductivity may block ion conduction.

As a specific example, the halide-based nanocomposite represented by Chemical Formula 1 may be ZrO₂-2Li₂ZrCl₆.

In Chemical Formula 2, the content of LiX may be 6-34 vol % and the content of LiₐM1X_{b} may be 66-94 vol %. Specifically, the content of LiX may be 7-9 vol % and the content of LiₐM1X_{b} may be 91-93 vol %. Particularly, if the content of LiX is below 7 vol %, a sufficient interfacial ion conductive phase cannot be formed. And, if it exceeds 9 vol %, the LiX having low ion conductivity may block the ion conduction of the solid electrolyte having high ion conductivity.

As a specific example, the halide-based nanocomposite represented by Chemical Formula 2 may be 3.06LiCl—Li₂ZrCl₆ or 0.53LiCl—Li₂ZrCl₆, most specifically 3.06LiCl—Li₂ZrCl₆.

In Chemical Formula 3, the content of LiX may be 1-29 vol %, the content of M1O_{c} may be 1-13 vol % and the content of LiₐM1X_{b} may be 65-94 vol %. Specifically, the content of LiX may be 2-25 vol %, the content of M1O_{c} may be 2-12 vol % and the content of LiₐM1X_{b} may be 66-93 vol %. More specifically, the content of LiX may be 2-25 vol %, the content of M1O_{c} may be 5-12 vol % and the content of LiₐM1X_{b} may be 66-93 vol %. Most specifically, the content of LiX may be 21-25 vol %, the content of M1O_{c} may be 8-12 vol % and the content of LiₐM1X_{b} may be 66-68 vol %. Particularly, if the content of M1O_{c} is below 5 vol %, a sufficient interfacial ion conductive phase cannot be formed. And, if it exceeds 12 vol %, the M1O_{c} having low ion conductivity may block the ion conduction of the solid electrolyte having high ion conductivity.

As a specific example, the halide-based nanocomposite represented by Chemical Formula 3 may be one or more selected from a group consisting of 2LiCl—ZrO₂—Li₂ZrCl₆, 1.26LiCl-0.44ZrO₂-0.56Li₂ZrCl₆, 1.51LiCl-0.38ZrO₂-0.63Li₂ZrCl₆, 2.03LiCl-0.25ZrO₂-0.75Li₂ZrCl₆, 3.06LiCl—Li₂ZrCl₆, 0.11LiCl-0.27ZrO₂-0.73Li₂ZrCl₆ and 0.31LiCl-0.14ZrO₂-0.86Li₂ZrCl₆, more specifically one or more selected from a group consisting of 0.11LiCl-0.27ZrO₂-0.73Li₂ZrCl₆, 2LiCl—ZrO₂—Li₂ZrCl₆ and 1.26LiCl-0.44ZrO₂-0.56Li₂ZrCl₆, most specifically 1.26LiCl-0.44ZrO₂-0.56Li₂ZrCl₆.

In Chemical Formula 1 or 3, the metal oxide M1O_{c} may be in-situ grown ZrO₂ having an average crystal size of 5-10 nm as observed by TEM analysis. If the particle size of the in-situ grown ZrO₂ exceeds 10 nm, dispersibility may decrease due to aggregation. The average crystal size of the in-situ grown ZrO₂ may be identified obviously by those having ordinary skill and may also be observed through TEM analysis.

The in-situ grown ZrO₂ may be formed in the form of a net formed in the LiₐM1X_{b} host of one selected from Chemical Formulas 1-3.

The in-situ grown ZrO₂ is advantageous in that it may be grown in situ by mechanical milling, higher ion conductivity can be achieved through wider abnormal interfacial ion conduction as compared to existing ZrO₂ particles owing to the metal oxide and the average grain size, and dispersibility and uniformity are superior due to the absence of aggregation. As a result, the interfacial stability between the sulfide-based solid electrolyte and the halide-based solid electrolyte and cycle stability can be enhanced. For the nanocomposite obtained by mixing the existing ZrO₂ particles with a size of 20 nm, a nanocomposite including in-situ grown ZrO₂ particle with a size of 5-10 nm cannot be formed, and the ZrO₂ particles inside the nanocomposite may have an average grain size exceeding 15 nm and may be unsatisfactory in terms of dispersibility and uniformity.

The halide-based nanocomposite may be one or more selected from a group consisting of ZrO₂-2Li₂ZrCl₆, 3.06LiCl—Li₂ZrCl₆, 0.53LiCl—Li₂ZrCl₆, 2LiCl—ZrO₂—Li₂ZrCl₆, 1.26LiCl-0.44ZrO₂-0.56Li₂ZrCl₆, 1.51LiCl-0.38ZrO₂-0.63Li₂ZrCl₆, 2.03LiCl-0.25ZrO₂-0.75Li₂ZrCl₆, 3.06LiCl—Li₂ZrCl₆, 0.11LiCl-0.27ZrO₂-0.73Li₂ZrCl₆ and 0.31LiCl-0.14ZrO₂-0.86Li₂ZrCl₆. It may be specifically one or more selected from a group consisting of ZrO₂-2Li₂ZrCl₆, 2LiCl—ZrO₂—Li₂ZrCl₆, 0.11LiCl-0.27ZrO₂-0.73Li₂ZrCl₆ and 1.26LiCl-0.44ZrO₂-0.56Li₂ZrCl₆, most specifically 1.26LiCl-0.44ZrO₂-0.56Li₂ZrCl₆.

The halide-based nanocomposite may have an ion conductivity of 0.1-5 mS/cm, specifically 0.7-3 mS/cm, more specifically 1.17-2 mS/cm, most specifically 1.28-1.33 mS/cm, at 30° C.

The halide-based nanocomposite may exhibit a crystal phase in X-ray diffraction (XRD) analysis and may have a glass-ceramic crystal structure. The glass-ceramic crystal structure has an X-ray diffraction pattern corresponding to that of hexagonal close-packed (hcp) trigonal Li₂ZrCl₆ (space group: P-3m1) and shows the possibility of low crystallinity and structural distortion due to the presence of broad peaks. Particularly, if the volume ratio of the lithium halide and the metal oxide is increased, the X-ray diffraction pattern of the hexagonal close-packed (hcp) trigonal Li₂ZrCl₆ (space group: P-3m1) may be decreased and a lithium halide-based X-ray diffraction pattern may occur.

The halide-based nanocomposite may exhibit a first effective peak and a second effective peak at 0.4-0.6 ppm and −0.2 to 0.2 ppm, respectively, in ⁶Li MAS NMR analysis, and the intensity ratio of the first effective peak to the second effective peak may be 0.7-0.8. In particular, the first effective peak indicates the occurrence of conduction of interfacial lithium ions.

As described above, the halide-based nanocomposite according to the present disclosure, which has a chemical structure represented by Chemical Formulas 1-3, may have superior atmospheric stability as compared to the existing oxide-based solid electrolyte.

Specifically, the halide-based nanocomposite, which has a structure of Chemical Formulas 1-3, may have improved atmospheric stability and significantly improved ion conductivity when the volume ratio of the components in the nanocomposite satisfies the optimal condition (Chemical Formula 1: M1O_{c} 6-9 vol % and LiₐM1X_{b} 91-94 vol %, Chemical Formula 2: LiX 6-34 vol % and LiₐM1X_{b} 66-94 vol %, Chemical Formula 3: LiX 1-29 vol %, M1O_{c} 1-13 vol % and LiₐM1X_{b} 65-94 vol %).

Most specifically, the halide-based nanocomposite satisfies all of the structure of Chemical Formulas 1-3, the optimal volume ratio of the components in the nanocomposite (Chemical Formula 1: M1O_{c} 7-8 vol % and LiₐM1X_{b} 92-93 vol %, Chemical Formula 2: LiX 7-9 vol % and LiₐM1X_{b} 91-93 vol %, Chemical Formula 3: LiX 2-25 vol %, M1O_{c} 5-12 vol % and LiₐM1X_{b} 66-93 vol %), the in-situ growth of the metal oxide component (ZrO₂) and the average grain size (5-10 nm). In this case, the halide-based nanocomposite has superior atmospheric stability and ion conductivity and the interfacial stability between the sulfide-based solid electrolyte and the halide-based solid electrolyte and cycle stability can be improved at the same time.

In contrast, if any of the above-described conditions is not satisfied, any of atmospheric stability, ion conductivity, interfacial stability and cycle stability may be unsatisfactory due to the tradeoff of physical properties.

The present disclosure also provides a positive electrode active material for a lithium-ion battery, which includes: a core including a positive electrode active material; and a shell surrounding the surface of the core and including the halide-based nanocomposite of the present disclosure.

A sulfide-based solid electrolyte is drawing a lot of attentions as a material suitable for an all-solid-state battery owing to high ion conductivity and soft mechanical property. However, because it is electrochemically unstable, severe side reactions may occur when contacted directly with a 4 V positive electrode active material. Recently, researches are being conducted on preparation of an oxide-based solid electrolyte as a shell to prevent direct contact of the sulfide-based solid electrolyte and the 4-V grade positive electrode active material.

However, although the oxide-based solid electrolyte shell can prevent the side reactions of the sulfide-based solid electrolyte, it lowers the performance of the all-solid-state battery as it acts as a resistance layer in the all-solid-state battery due to low ion conductivity. In the present disclosure, by forming a positive electrode active material by replacing the oxide-based solid electrolyte shell with the halide-based nanocomposite of the present disclosure shell, the side reactions between the positive electrode active material and the sulfide-based solid electrolyte can be prevented and, at the same time, an all-solid-state battery with superior performance can be provided by minimizing the internal resistance of the all-solid-state battery owing to superior ion conductivity.

The present disclosure also provides a solid electrolyte for a lithium-ion battery including the halide-based nanocomposite according to the present disclosure and a sulfide-based solid electrolyte.

The sulfide-based solid electrolyte may be Li_{7+x-y}Mₓ⁴⁺M₁₋ₓ⁵⁺S_{6-y}X_{y} (M⁴⁺: Si, Ge, Sn; M⁵⁺: P, Sb; X: Cl, Br, I, 0≤x≤1, 0≤y≤2), Li₁₀₊ₐ[GebM⁴⁺_{1-b}]₁₊ₐP₂₋ₐS_{12-c}X_{c} (M⁴⁺: Si, Sn; X: Cl, Br, I, 0≤a≤2, 0≤b≤1, 0≤c≤4) or a mixture thereof, although not being limited thereto.

As a specific example, the Li_{7+x-y}Mx⁴⁺M₁₋ₓ⁵⁺S_{6-y}X_{y} may be Li₆PS₅Cl and the Li₁₀₊ₐ[Ge_{b}M⁴⁺_{1-b}]₁₊ₐP₂₋ₐS_{12-c} may be Li_{9.54}Si_{1.74}P_{1.44}S_{11.7}Cl_{0.3}.

The present disclosure also provides a double-layer solid electrolyte for a lithium-ion battery, which contains: a solid electrolyte for a positive electrode, which contains the halide-based nanocomposite according to the present disclosure; and a solid electrolyte for a negative electrode, which is formed on the solid electrolyte for a positive electrode and contains a sulfide-based solid electrolyte.

Since the solid electrolytes contain the halide-based nanocomposite, there is no risk of evolution of hydrogen sulfide and they have excellent oxidation stability like oxides and can be usefully used in an all-solid-state battery. Particularly, the double-layer solid electrolyte, which contains the halide-based nanocomposite, can solve the problem of interfacial side reactions between the solid electrolyte for a positive electrode and the solid electrolyte for a negative electrode in the all-solid-state battery and can exhibit superior cycle stability.

The present disclosure also provides an all-solid-state battery including: a positive electrode; a negative electrode; and the solid electrolyte according to the present disclosure, which is disposed between the positive electrode and the negative electrode.

The solid electrolyte may contain the halide-based nanocomposite according to the present disclosure and a sulfide-based solid electrolyte.

The present disclosure also provides an all-solid-state battery, which includes: a positive electrode; a negative electrode; and the double-layer solid electrolyte according to the present disclosure, which is disposed between the positive electrode and the negative electrode, wherein the positive electrode is positioned on the solid electrolyte for a positive electrode of the double-layer solid electrolyte, and the negative electrode is positioned on the solid electrolyte for a negative electrode.

The double-layer solid electrolyte may contain: a solid electrolyte for a positive electrode, which contains the halide-based nanocomposite according to the present disclosure; and a solid electrolyte for a negative electrode, which is formed on the solid electrolyte for a positive electrode and contains a sulfide-based solid electrolyte.

The present disclosure also provides a device including the all-solid-state battery according to the present disclosure, wherein the device is one selected from a communication device, a transportation device and an energy storage device.

The present disclosure also provides an electrical device including the all-solid-state battery according to the present disclosure, wherein the electrical device is one selected from an electric vehicle, a hybrid electric vehicle, a plug-in hybrid electric vehicle and a power storage device.

The present disclosure also provides a method for preparing a halide-based nanocomposite for a solid electrolyte of a lithium-ion battery, which includes: a step of preparing a halide-based nanocomposite represented by at least one of Chemical Formulas 1-3 by mixing a lithium oxide precursor with a metal halide precursor in solid state under inert gas atmosphere:

M1O_{c}—LiₐM1X_{b} [Chemical Formula 1]

(wherein M1 is one or more selected from a group consisting of Ti, Zr and Hf, X is Cl, Br, F or I, and each of a, b and c is independently a real number of 0.1-10)

LiX—LiₐM1X_{b} [Chemical Formula 2]

(wherein M1 is one or more selected from a group consisting of Ti, Zr and Hf, X is Cl, Br, F or I, and each of a, b and c is independently a real number of 0.1-10)

M1O_{c}—LiX—LiₐM1X_{b} [Chemical Formula 3]

(wherein M1 is one or more selected from a group consisting of Ti, Zr and Hf, X is Cl, Br, F or I, and each of a, b and c is independently a real number of 0.1-10).

Because the lithium oxide precursor has the characteristics of an oxidizing agent, it may react with a metal halide to form a lithium halide and a metal oxide, and these products may improve the ion conductivity of the halide-based nanocomposite by creating a space charge layer at the solid electrolyte interface. Furthermore, the lithium halide and the metal oxide may prevent interfacial side reactions between the halide-based solid electrolyte and the sulfide-based solid electrolyte at high temperatures and high voltages by blocking direct contact of the halide-based solid electrolyte and the sulfide-based solid electrolyte. The lithium oxide precursor may be one or more selected from a group consisting of Li₂O, Li₂CO3, Li₂SO₄ and LiNO₃, specifically Li₂O, LiNO₃ or a mixture thereof, most specifically Li₂O.

Because the metal halide precursor is abundant in the Earth's crust and contains inexpensive elements, it allows the preparation of an inexpensive solid electrolyte. The metal halide precursor may be one or more selected from a group consisting of TiCl₄, TiBr₄, ZrCl₄, ZrBr₄, HfCl₄ and HfBr₄, specifically ZrCl₄, ZrBr₄ or a mixture thereof, most specifically ZrCl₄.

In the step of preparing the precursor mixture, the precursor mixture may be prepared by further mixing a lithium halide precursor. When the lithium halide precursor is further mixed, electrochemical stability and ion conductivity may be improved by controlling the volume ratio of the halide-based nanocomposite.

The lithium halide precursor may be one or more selected from a group consisting of LiCl, LiBr, LiF and LiI, specifically LiCl, LiBr or a mixture thereof, most specifically LiCl. Particularly, if the precursor mixture is prepared by further mixing the lithium halide precursor, a halide-based nanocomposite represented by Chemical Formula 3 may be formed through Scheme 1.

aLiCl+bZrCl₄+cLi₂O→(a−2b+c)LiCl+c/2ZrO₂+(b−c/2)Li₂ZrCl₆

(wherein a satisfies 0≤a≤6, b satisfies 0≤b≤2 and c satisfies 0≤c≤3)

In Scheme 1, Li₂O may oxidize ZrCl₄ to form LiCl and in-situ grown ZrO₂, and the remaining LiCl may be bonded to ZrCl₄ to form Li₂ZrCl₆. The produced LiCl, in-situ grown ZrO₂ and Li₂ZrCl₆ may be bonded to form a halide-based nanocomposite with a structure of ZrO₂—LiCl—Li₂ZrCl₆.

The in-situ grown ZrO₂ in the halide-based nanocomposite may increase, upon reaction with a halide-based solid electrolyte, the ion conductivity of the solid electrolyte at the interface and, upon reaction with a sulfide-based solid electrolyte, may decrease reactivity at high voltages, thereby providing an all-solid-state battery having high energy density.

The inert gas may be one or more selected from a group consisting of argon, helium, neon and nitrogen, specifically argon or helium, most specifically argon.

The mixing in solid state may be performed by mechanical milling selected from a group consisting of ball milling, vibration milling, turbo milling, mechanofusion and disc milling, specifically by ball milling or vibration milling, most specifically by ball milling. The halide-based nanocomposite obtained through the mechanical milling may have ion conductivity improved by 2-10 times as compared to the existing halide-based solid electrolyte material. The mechanical milling may be performed at 300-800 rpm for 10-50 hours, specifically at 500-700 rpm for 7-18 hours, most specifically at 580-620 rpm for 9-11 hour.

Particularly, although it is not described explicitly in the examples, comparative examples, etc., all-solid-state batteries were prepared using the solid electrolytes containing halide-based nanocomposites according to the present disclosure prepared by varying the following seven conditions. For the prepared all-solid-state batteries, durability was tested after 2000 charge-discharge cycles.

As a result, it was confirmed that the all-solid-state battery has good durability even after 2000 charge-discharge cycles due to strong binding between the electrode and the solid electrolyte when all of the following conditions are satisfied.

1) The metal oxide precursor is Li₂O, LiNO₃ or a mixture thereof. 2) The metal halide precursor is ZrCl₄, ZrBr₄ or a mixture thereof. 3) The halide-based nanocomposite is prepared by further mixing a lithium halide precursor. 4) The lithium halide precursor is LiCl, LiBr or a mixture thereof. 5) The halide-based nanocomposite is represented by Chemical Formula 1 or 3 and, in Chemical Formula 1, the content of M1O_{c} is 7-8 vol % and the content of LiₐM1X_{b} is 92-93 vol %. 6) In Chemical Formula 3, the content of LiX is 2-25 vol %, the content of M1O_{c} is 5-12 vol % and the content of LiₐM1X_{b} is 66-93 vol %. 7) In Chemical Formula 1 or 3, the M1O_{c} is in-situ grown ZrO₂ having an average crystal size of 5-10 nm as observed by TEM analysis.

When any of the seven conditions was not satisfied, significant loss of the halide-based nanocomposite in the solid electrolyte occurred after 2000 charge-discharge cycles. Particularly, although it is not described explicitly in the examples, comparative examples, etc., all-solid-state batteries were prepared using the solid electrolytes containing halide-based nanocomposites according to the present disclosure prepared by varying the following twelve conditions. For the prepared all-solid-state batteries, charge-discharge capacity, battery life characteristics and capacity retention rate were tested after 2000 charge-discharge cycles.

As a result, it was confirmed that the all-solid-state battery retains high charge-discharge capacity even after 2000 charge-discharge cycles due to strong binding between the electrode and the solid electrolyte, exhibits low decrease in output density as about 10% after 2000 charge-discharges and retains high capacity retention rate as 90% or higher when all of the following conditions are satisfied.

1) The metal oxide precursor is Li₂O, LiNO₃ or a mixture thereof. 2) The metal halide precursor is ZrCl₄, ZrBr₄ or a mixture thereof. 3) The halide-based nanocomposite is prepared by further mixing a lithium halide precursor. 4) The lithium halide precursor is LiCl, LiBr or a mixture thereof. 5) The inert gas is argon. 6) The mixing in solid state is performed by mechanical milling selected from ball milling and vibration milling. 7) The mechanical milling is performed at 500-700 rpm for 7-18 hours. 8) The halide-based nanocomposite is represented by Chemical Formula 3 and, in Chemical Formula 3, the content of LiX is 2-25 vol %, the content of M1O_{c} is 5-12 vol % and the content of LiₐM1X_{b} is 66-93 vol %. 9) In Chemical Formula 3, the M1O_{c} is in-situ grown ZrO₂ having an average crystal size of 5-10 nm as observed by TEM analysis. 10) The in-situ grown ZrO₂ is formed in the form of a net formed in the LiₐM1X_{b} host of Chemical Formula 3. 11) The halide-based nanocomposite is 1.26LiCl-0.44ZrO₂-0.56Li₂ZrCl₆ or 0.11LiCl-0.27ZrO₂-0.73Li₂ZrCl₆. 12) The halide-based nanocomposite has an ion conductivity of 1.17-2 mS/cm at 30° C.

When any of the twelve conditions was not satisfied, the durability and stability of the all-solid-state battery were degraded rapidly as cracks were formed in the solid electrolyte after 2000 charge-discharge cycles.

Particularly, although it is not described explicitly in the examples, comparative examples, etc., all-solid-state batteries were prepared using the solid electrolytes containing halide-based nanocomposites according to the present disclosure prepared by varying the following thirteen conditions. For the prepared all-solid-state batteries, the state and composition of the solid electrolytes were evaluated and oxidation stability was tested after 2000 charge-discharge cycles.

As a result, it was confirmed that no loss or crack of the solid electrolyte occurs even after 2000 charge-discharge cycles and the composition of the halide-based nanocomposite in the solid electrolyte is maintained stably without oxidation when all of the following conditions are satisfied.

1) The metal oxide precursor is Li₂O. 2) The metal halide precursor is ZrCl₄. 3) The halide-based nanocomposite is prepared by further mixing a lithium halide precursor. 4) The lithium halide precursor is LiCl. 5) The inert gas is argon. 6) The mixing in solid state is performed by mechanical milling which is ball milling. 7) The mechanical milling is performed at 580-620 rpm for 9-11 hours. 8) The halide-based nanocomposite is represented by Chemical Formula 3 and, in Chemical Formula 3, the content of LiX is 2-25 vol %, the content of M1O_{c} is 5-12 vol % and the content of LiₐM1X_{b} is 66-93 vol %. 9) In Chemical Formula 3, the M1O_{c} is in-situ grown ZrO₂ having an average crystal size of 5-10 nm as observed by TEM analysis. 10) The in-situ grown ZrO₂ is formed in the form of a net formed in the LiₐM1X_{b} host of Chemical Formula 3. 11) The halide-based nanocomposite is 1.26LiCl-0.44ZrO₂-0.56Li₂ZrCl₆. 12) The halide-based nanocomposite has an ion conductivity of 1.28-1.33 mS/cm at 30° C. 13) The halide-based nanocomposite exhibits a first effective peak and a second effective peak at 0.4-0.6 ppm and −0.2 to 0.2 ppm, respectively, in ⁶Li MAS NMR analysis, and the intensity ratio of the first effective peak to the second effective peak is 0.7-0.8.

When any of the thirteen conditions was not satisfied, some elements of the halide-based nanocomposite in the solid electrolyte were lost due to oxidation and dissolution after 2000 charge-discharge cycles.

Hereinafter, the present disclosure will be described more specifically through examples. However, the present disclosure is not limited by the examples.

### EXAMPLES 1-10 AND COMPARATIVE EXAMPLE 1: PREPARATION OF HALIDE-BASED NANOCOMPOSITE

After adding Li₂O, LiCl and ZrCl₄ as precursors at molar ratios described in Table 1, a precursor mixture powder was prepared by conducting mechanical milling in a 50-mL ZrO₂ vial containing 15 ZrO₂ balls (&=10 mm) using Pulverisette 7 PL (Fritsch GmbH) at 600 rpm for 10 hours under Ar atmosphere. The prepared halide-based nanocomposite was used as a solid electrolyte.

TABLE 1

| | Precursors (molar ratio) | | | |
|---|---|---|---|---|
| | Li₂O | LiCl | ZrCl₄ | Halide-based nanocomposite |
| Comp. Ex. 1 | — | 2 | 1 | Li₂ZrCl₆ |
| Example 1 | 2 | — | 3 | ZrO₂-2Li₂ZrCl₆ |
| Example 2 | 1 | — | 1 | 2LiCl-ZrO₂-Li₂ZrCl₆ |
| Example 3 | 2 | — | 1 | 4LiCl-ZrO₂ |
| Example 4 | 0.875 | 0.6325 | 1 | 1.26LiCl-0.44ZrO₂-0.56Li₂ZrCl₆ |
| Example 5 | 0.75 | 1.265 | 1 | 1.51LiCl-0.38ZrO₂-0.63Li₂ZrCl₆ |
| Example 6 | 0.5 | 2.53 | 1 | 2.03LiCl-0.25ZrO₂-0.75Li₂ZrCl₆ |
| Example 7 | — | 5.06 | 1 | 3.06LiCl-Li₂ZrCl₆ |
| Example 8 | 0.535 | 0.5 | 1 | 0.11LiCl-0.27ZrO₂-0.73Li₂ZrCl₆ |
| Example 9 | 0.2715 | 1.5 | 1 | 0.31LiCl-0.14ZrO₂-0.86Li₂ZrCl₆ |
| Example 10 | — | 2.53 | 1 | 0.53LiCl-Li₂ZrCl₆ |

### COMPARATIVE EXAMPLE 2: PREPARATION OF HALIDE-BASED NANOCOMPOSITE

A halide-based nanocomposite with a structure of 0.5ZrO₂(20 nm)-Li₂ZrCl₆ was prepared by milling ZrO₂ having a particle size of 20 nm LiCl and ZrCl₄ in the same manner as in Example 1.

### TEST EXAMPLE 1: XRD ANALYSIS AND EVALUATION OF ION CONDUCTIVITY

For the halide-based nanocomposites prepared in Comparative Example 1 and Examples 1-10, crystal structure was analyzed by X-ray diffraction (XRD) and ion conductivity was measured. The result is shown in Table 2 and FIG. 1.

TABLE 2

| | | | | Ion | | | | |
|---|---|---|---|---|---|---|---|---|
| | Precursors (molar ratio) | | | conductivity | Halide-based | Composite (volume ratio) | | |
| | Li₂O | LiCl | ZrCl₄ | (mS/cm) | nanocomposite | LiCl | ZrO₂ | Li₂ZrCl₆ |
| Comp. | — | 2 | 1 | 0.4 | Li₂ZrCl₆ | 0.00% | 0.00% | 100.0% |
| Ex. 1 | | | | | | | | |
| Ex. 1 | 2 | — | 3 | 1.17 | ZrO₂-2Li₂ZrCl₆ | 0.00% | 7.86% | 92.14% |
| Ex. 2 | 1 | — | 1 | 1.28 | 2LiCl-ZrO₂-Li₂ZrCl₆ | 21.58% | 11.43% | 66.99% |
| Ex. 3 | 2 | — | 1 | 0.0002 | 4LiCl-ZrO₂ | 79.06% | 20.94% | 0.00% |
| Ex. 4 | 0.875 | 0.6325 | 1 | 1.33 | 1.26LiCl-0.44ZrO₂- | 24.12% | 8.89% | 66.99% |
| | | | | | 0.56Li₂ZrCl₆ | | | |
| Ex. 5 | 0.75 | 1.265 | 1 | 1.02 | 1.51 LiCl-0.38ZrO₂- | 26.16% | 6.86% | 66.98% |
| | | | | | 0.63Li₂ZrCl₆ | | | |
| Ex. 6 | 0.5 | 2.53 | 1 | 0.67 | 2.03LiCl-0.25ZrO₂- | 29.21% | 3.81% | 66.98% |
| | | | | | 0.75Li₂ZrCl₆ | | | |
| Ex. 7 | — | 5.06 | 1 | 0.28 | 3.06LiCl-Li₂ZrCl₆ | 33.02% | 0.00% | 66.98% |
| Ex. 8 | 0.535 | 0.5 | 1 | 1.17 | 0.11LiCl-0.27ZrO₂- | 2.13% | 5.74% | 92.13% |
| | | | | | 0.73Li₂ZrCl₆ | | | |
| Ex. 9 | 0.2715 | 1.5 | 1 | 1.10 | 0.31LiCl-0.14ZrO₂- | 5.40% | 2.47% | 92.13% |
| | | | | | 0.86Li₂ZrCl₆ | | | |
| Ex. 10 | — | 2.53 | 1 | 0.7 | 0.53LiCl-Li₂ZrCl₆ | 7.87% | 0.00% | 92.13% |

Although it was not shown in Table 2, the halide-based nanocomposites of Examples 1-10 formed by mixing Li₂O and ZrCl₄ or mixing Li₂O, ZrCl₄ and LiCl commonly exhibited superior atmospheric stability as compared to the existing oxide-based solid electrolyte.

Referring to Table 2, for Examples 1 and 2, halide-based nanocomposites with a structure of any of Chemical Formulas 1 and 3 could be obtained when the components in the composites satisfied a specific volume ratio, and they showed superior atmospheric stability and high ion conductivity only when Li₂O and ZrCl₄ were mixed and the specific volume ratio was satisfied.

However, for Example 3, the components in the composites could not satisfy the specific volume ratio even when Li₂O and ZrCl₄ were mixed. As a result, although atmospheric stability was superior, ion conductivity was significantly low, and a halide-based nanocomposite with a chemical structure of any of Chemical Formulas 1-3 was not formed. And, for Examples 7 and 10, wherein ZrO₂ was not contained in the composite although LiCl and ZrCl₄ were mixed, atmospheric stability was superior but lithium ion conductivity was relatively low.

For Examples 4-6, 8 and 9, wherein Li₂O, LiCl and ZrCl₄ were mixed and the components in the composites satisfied the specific volume ratio, it was confirmed that atmospheric stability and lithium ion conductivity were improved.

Particularly, for Example 4, wherein Li₂O, LiCl and ZrCl₄ were mixed, the component in the composites satisfied the specific volume ratio and in-situ grown ZrO₂ having an average crystal size of 5-10 nm was contained in the composite, it was confirmed that atmospheric stability was superior and lithium ion conductivity was the most superior. In addition, although it was not shown in Table 2, the interfacial stability between the sulfide-based solid electrolyte and the halide-based solid electrolyte and cycle stability were improved significantly.

FIG. 1 shows the XRD analysis result of solid electrolytes containing the halide-based nanocomposites prepared in Examples 1-4, 7 and 10 and Comparative Example 1. Referring to FIG. 1, Example 1 showed peaks similar to those of Comparative Example 1. The X-ray diffraction pattern corresponded to that of hexagonal close-packed (hcp) trigonal Li₂ZrCl₆ (space group: P-3m1) and the broad peaks showed the possibility of low crystallinity and structural distortion.

For Example 2, it was confirmed that the X-ray diffraction pattern of Li₂ZrCl₆ (space group: P-3m1) was decreased and the X-ray diffraction pattern of LiCl occurred as the molar ration of the lithium halide and the metal oxide was increased. For

Example 3, wherein no solid electrolyte was contained, the X-ray diffraction patterns of LiCl and ZrO₂ were more distinct. For Example 4, the X-ray diffraction patterns of Li₂ZrCl₆ (space group: P-3m1) and LiCl were observed at the same time.

### TEST EXAMPLE 2-1: NMR ANALYSIS

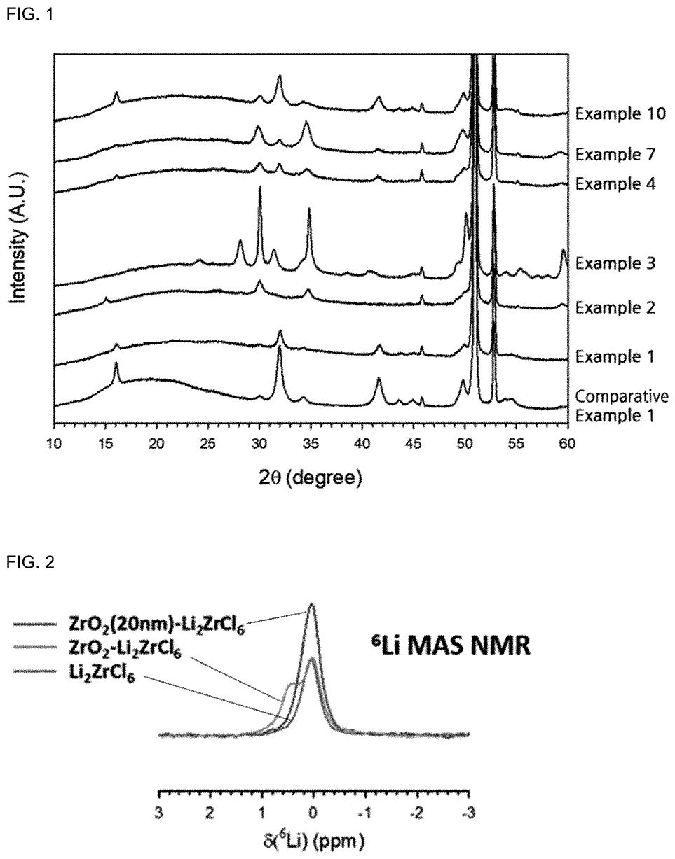

⁶Li MAS NMR analysis was conducted to investigate interfacial lithium ion conduction for the halide-based nanocomposites prepared in Comparative Examples 1-2 and Example 1. For comparison, a halide-based nanocomposite with a structure of ZrO₂(20 nm)-Li₂ZrCl₆ was prepared in the same manner as in Example 4 by milling ZrO₂ having a particle size of 20 nm, LiCl and ZrCl₃. The result is shown in FIG. 2.

FIG. 2 shows the ⁶Li MAS NMR analysis result of the halide-based nanocomposites prepared in Comparative Example 1 (Li₂ZrCl₆), Comparative Example 2 (ZrO₂(20 nm)-2Li₂ZrCl₆) and Example 1 (ZrO₂-2Li₂ZrCl₆). Referring to FIG. 2, it can be seen that an additional peak attributed to interfacial lithium ion conduction was observed in the ⁶Li MAS NMR analysis for the halide nanocomposite formed by in-situ growth in Example 1 as compared to Comparative Examples 1 and 2.

### TEST EXAMPLE 2-2: TEM ANALYSIS

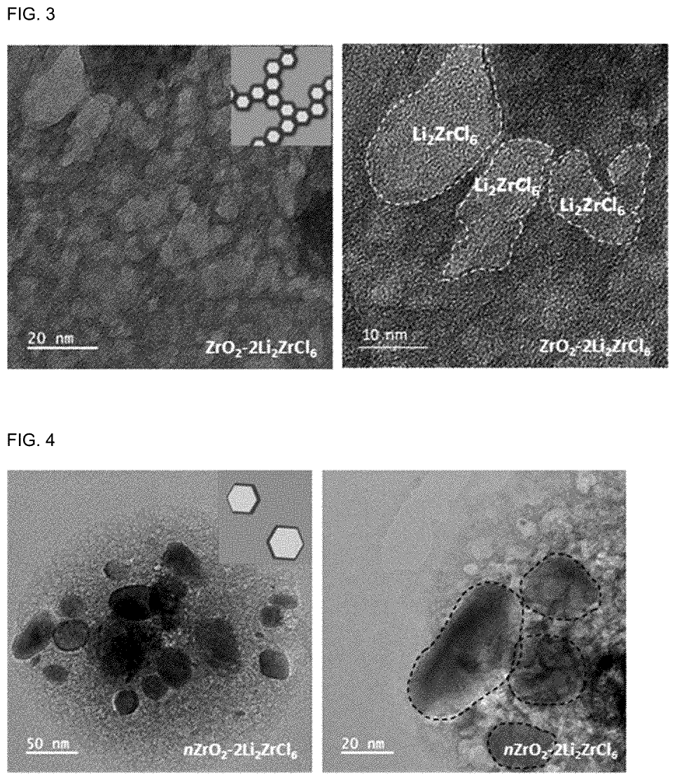

TEM analysis was conducted to investigate the morphology and average crystal size of the in-situ grown ZrO₂ in the nanocomposite for the halide-based nanocomposites prepared in Example 4 and Comparative Example 2. The result is shown in FIGS. 3 and 4.

FIG. 3 shows the TEM images of the halide-based nanocomposite prepared in Example 4. Referring to FIG. 3, it can be seen that in-situ grown ZrO₂ with an average crystal size of 5-10 nm was formed in the halide-based nanocomposite of Example 4. It was confirmed that, unlike existing ZrO₂ particles, the in-situ grown ZrO₂ does not aggregate, improves ion conductivity owing to superior dispersibility and uniformity, and enhances the interfacial stability between the sulfide-based solid electrolyte and the halide-based solid electrolyte and cycle stability.

FIG. 4 shows the TEM images of the 0.5ZrO₂—Li₂ZrCl₆ halide-based nanocomposite prepared in Comparative Example 1. Referring to FIG. 4, the halide-based nanocomposite had an average crystal size exceeding 15 nm due to the aggregation of ZrO₂ particles. In addition, because of the significantly decreased dispersibility and uniformity of the ZrO₂ particles, ion conductivity, the interfacial stability between the solid electrolytes and cycle stability were unsatisfactory.

### TEST EXAMPLE 2-3: ION CONDUCTIVITY ANALYSIS

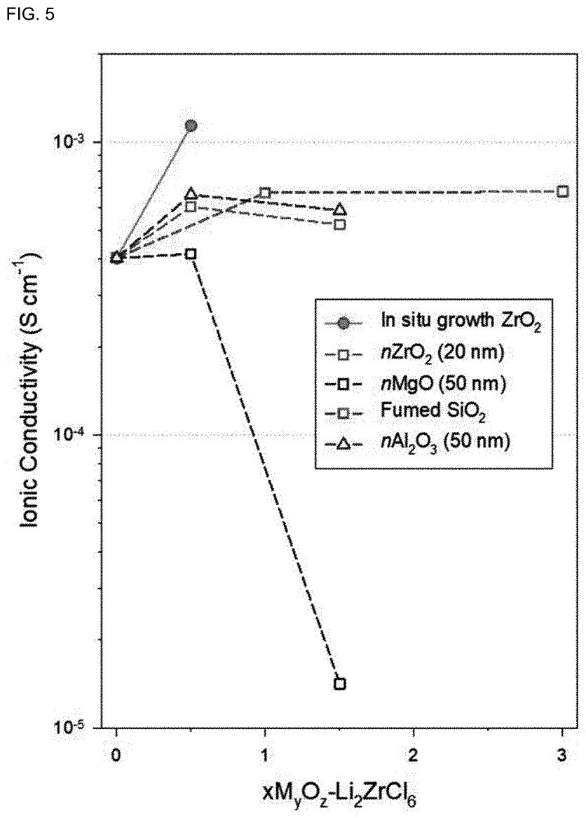

The ion conductivity of the in-situ grown ZrO₂ in the halide-based nanocomposite prepared in Example 4 was measured. The result is shown in FIG. 5. Additionally, 20 nm-ZrO₂, 50 nm-MgO, fumed SiO₂ and 50 nm-Al₂O₃ having nano-scale particle sizes were prepared.

FIG. 5 shows the result of measuring ion conductivity for the ZrO₂ particles grown in situ in the halide-based nanocomposite prepared in Example 4 and the 20 nm-ZrO₂, 50 nm-MgO, fumed SiO₂ and 50 nm-Al₂O₃ particles mixed in existing halide-based nanocomposites.

Referring to FIG. 5, it was confirmed that both the in-situ grown ZrO₂ particles of Example 4 and the existing 20 nm-ZrO₂ particles contributed to the improvement of ion conductivity. But, the in-situ grown ZrO₂ particles of Example 4, which were grown in-situ through mechanical synthesis and had an average crystal size of 5-10 nm, showed the most superior ion conductivity owing to activation of wider interfacial conduction as compared to the 20 nm-ZrO₂ particles having a crystal size exceeding 15 nm. Although the existing particles also showed improved ion conductivity, the degree of improvement was insignificant when compared with Example 4.

### TEST EXAMPLE 3: EVALUATION OF CHARGE-DISCHARGE CHARACTERISTICS

All-solid-state batteries were prepared using the solid electrolytes prepared in Example 1 and Comparative Example 1 according to a common method as follows. A positive electrode layer was prepared using LiCoO₂ as a positive electrode active material and Super-C as a conductive material and mixing the positive electrode active material, the solid electrolyte and the conductive material at a weight ratio of 70:30:3. An all-solid-state battery was prepared using the positive electrode layer, a solid electrolyte layer including the halide-based nanocomposite and Li—In as a negative electrode.

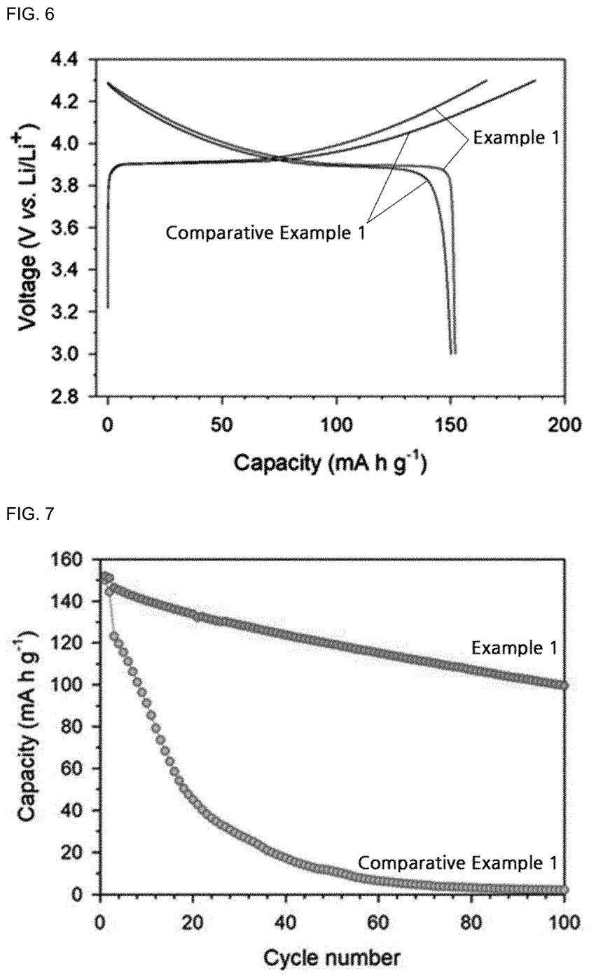

After charging the prepared all-solid-state battery at 60° C. to 4.3 V at constant current, the charging was stopped when the current at 4.3 V reached 0.005 C. The charge-discharge characteristics of the battery were evaluated by discharging the battery to 3.0 V at constant current. The result is shown in FIGS. 6 and 7.

FIG. 6 shows the voltage-capacity curves of the all-solid-state batteries prepared using the solid electrolytes of Example 1 and Comparative Example 1 for initial charge-discharge cycles. Referring to FIG. 6, Example 1 showed a high initial charge-discharge capacity of about 151.9 mAh/g, whereas Comparative Example 1 showed a low initial charge-discharge capacity of 150.8 mAh/g.

FIG. 7 shows the discharge capacity curves of the all-solid-state batteries prepared using the solid electrolytes of Example 1 and Comparative Example 1 depending on cycle numbers. Referring to FIG. 7, for Comparative Example 1, wherein LiCl and ZrO₂ contributing to the improvement of ion conductivity were not contained, showed significant decrease in capacity due to severe side reactions with the sulfide-based solid electrolyte. In contrast, for Example 1, although discharge capacity was decreased as the number of charge-discharge cycles was increased, it can be seen that the charge-discharge was improved because the decrease was smaller than that of Comparative Example 1.

As described above, the solid electrolyte containing the halide-based nanocomposite of the present disclosure had superior electrochemical oxidation stability and ion conductivity as compared to the existing sulfide-based solid electrolyte and could improve the reactivity with the sulfide-based solid electrolyte at high voltages. In addition, it exhibited higher stability and improved battery charge-discharge performance as compared to a battery using an organic liquid electrolyte.

We claim:

1. A halide-based nanocomposite for a solid electrolyte of a lithium-ion battery, represented by at least one of Chemical Formulas 1-3:
M1O_{c}—LiₐM1X_{b} [Chemical Formula 1]
(wherein M1 is one or more selected from a group consisting of Ti, Zr and Hf, X is Cl, Br, F or I, and each of a, b and c is independently a real number of 0.1-10)
LiX—LiₐM1X_{b} [Chemical Formula 2]
(wherein M1 is one or more selected from a group consisting of Ti, Zr and Hf, X is Cl, Br, F or I, and each of a, b and c is independently a real number of 0.1-10)
M1O_{c}—LiX—LiₐM1X_{b} [Chemical Formula 3]
(wherein M1 is one or more selected from a group consisting of Ti, Zr and Hf, X is Cl, Br, F or I, and each of a, b and c is independently a real number of 0.1-10).

2. The halide-based nanocomposite for a solid electrolyte of a lithium-ion battery according to claim 1, wherein, in Chemical Formula 1, the content of M1O_{c} is 1-20 vol % and the content of LiₐM1X_{b} is 80-99 vol %.

3. The halide-based nanocomposite for a solid electrolyte of a lithium-ion battery according to claim 1, wherein, in Chemical Formula 2, the content of LiX is 6-34 vol % and the content of LiₐM1X_{b} is 66-94 vol %.

4. The halide-based nanocomposite for a solid electrolyte of a lithium-ion battery according to claim 1, wherein, in Chemical Formula 3, the content of LiX is 1-29 vol %, the content of M1O_{c} is 1-13 vol % and the content of LiₐM1X_{b} is 65-94 vol %.

5. The halide-based nanocomposite for a solid electrolyte of a lithium-ion battery according to claim 1, wherein, in Chemical Formula 1 or 3, the M1O_{c} is in-situ grown ZrO₂ having an average crystal size of 5-10 nm as observed by TEM analysis.

6. The halide-based nanocomposite for a solid electrolyte of a lithium-ion battery according to claim 5, wherein the in-situ grown ZrO₂ is formed in the form of a net formed in the LiₐM1X_{b} host of one selected from Chemical Formulas 1-3.

7. The halide-based nanocomposite for a solid electrolyte of a lithium-ion battery according to claim 5, wherein the halide-based nanocomposite is one or more selected from a group consisting of ZrO₂-2Li₂ZrCl₆, 3.06LiCl—Li₂ZrCl₆, 0.53LiCl—Li₂ZrCl₆, 2LiCl—ZrO₂-Li₂ZrCl₆, 1.26LiCl-0.44ZrO₂-0.56Li₂ZrCl₆, 1.51LiCl-0.38ZrO₂-0.63Li₂ZrCl₆, 2.03LiCl-0.25ZrO₂-0.75Li₂ZrCl₆, 3.06LiCl—Li₂ZrCl₆, 0.11LiCl-0.27ZrO₂-0.73Li₂ZrCl₆ and 0.31LiCl-0.14ZrO₂-0.86L12ZrCl₆.

8. The halide-based nanocomposite for a solid electrolyte of a lithium-ion battery according to claim 1, wherein the halide-based nanocomposite has an ion conductivity of 0.1-5 mS/cm at 30° C.

9. The halide-based nanocomposite for a solid electrolyte of a lithium-ion battery according to claim 1, wherein the halide-based nanocomposite has a glass-ceramic crystal structure.

10. A positive electrode active material for a lithium-ion battery, comprising:
a core comprising a positive electrode active material; and
a shell surrounding the surface of the core and comprising the halide-based nanocomposite according to claim 1.

11. A solid electrolyte for a lithium-ion battery, comprising the halide-based nanocomposite according to claim 1 and a sulfide-based solid electrolyte.

12. The solid electrolyte for a lithium-ion battery according to claim 11, wherein the sulfide-based solid electrolyte is Li_{7+x-y}Mx⁴⁺M₁₋ₓ⁵⁺S_{6-y}X_{y} (M⁴⁺: Si, Ge, Sn; M⁵⁺: P, Sb; X: Cl, Br, I, 0≤x≤1, 0≤y≤2), Li₁₀₊ₐ[Ge_{b}M⁴⁺_{1-b}]_{1-30 a}P₂₋ₐS_{12-c}(M⁴⁺: Si, Sn; X: Cl, Br, I, 0≤a≤2, 0≤b≤1, 0≤c≤4) or a mixture thereof.

13. A double-layer solid electrolyte for a lithium-ion battery, comprising
a solid electrolyte for a positive electrode, comprising the halide-based nanocomposite according to claim 1; and
a solid electrolyte for a negative electrode, formed on the solid electrolyte for a positive electrode and comprising a sulfide-based solid electrolyte.

14. An all-solid-state battery comprising: a positive electrode; a negative electrode; and the solid electrolyte according to claim 11, which is disposed between the positive electrode and the negative electrode.

15. An all-solid-state battery comprising: a positive electrode; a negative electrode; and the double-layer solid electrolyte according to claim 13, which is disposed between the positive electrode and the negative electrode,
wherein the positive electrode is positioned on the solid electrolyte for a positive electrode of the double-layer solid electrolyte, and the negative electrode is positioned on the solid electrolyte for a negative electrode.

16. A device comprising the all-solid-state battery according to claim 14,
wherein the device is one selected from a communication device, a transportation device and an energy storage device.

17. An electrical device comprising the all-solid-state battery according to claim 14,
wherein the electrical device is one selected from an electric vehicle, a hybrid electric vehicle, a plug-in hybrid electric vehicle and a power storage device.

18. A method for preparing a halide-based nanocomposite for a solid electrolyte of a lithium-ion battery, comprising preparing a halide-based nanocomposite represented by at least one of Chemical Formulas 1-3 by mixing a lithium oxide precursor with a metal halide precursor in solid state under inert gas atmosphere:
M1O_{c}—LiₐM1X_{b} [Chemical Formula 1]
(wherein M1 is one or more selected from a group consisting of Ti, Zr and Hf, X is Cl, Br, F or I, and each of a, b and c is independently a real number of 0.1-10)
LiX—LiₐM1X_{b} [Chemical Formula 2]
(wherein M1 is one or more selected from a group consisting of Ti, Zr and Hf, X is Cl, Br, F or I, and each of a, b and c is independently a real number of 0.1-10)
M1O_{c}—LiX—LiₐM1X_{b} [Chemical Formula 3]
(wherein M1 is one or more selected from a group consisting of Ti, Zr and Hf, X is Cl, Br, F or I, and each of a, b and c is independently a real number of 0.1-10).

19. The method for preparing a halide-based nanocomposite for a solid electrolyte of a lithium-ion battery according to claim 18, wherein the lithium oxide precursor is one or more selected from a group consisting of Li₂O, Li₂CO₃, Li₂SO₄ and LiNO₃.

20. The method for preparing a halide-based nanocomposite for a solid electrolyte of a lithium-ion battery according to claim 18, wherein the metal halide precursor is one or more selected from a group consisting of TiCl₄, TiBr₄, ZrCl₄, ZrBr₄, HfCl₄ and HfBr₄.

21. The method for preparing a halide-based nanocomposite for a solid electrolyte of a lithium-ion battery according to claim 18, wherein the halide-based nanocomposite is prepared by further mixing a lithium halide precursor.

22. The method for preparing a halide-based nanocomposite for a solid electrolyte of a lithium-ion battery according to claim 21, wherein the lithium halide precursor is one or more selected from a group consisting of LiCl, LiBr, LiF and LiI.

23. The method for preparing a halide-based nanocomposite for a solid electrolyte of a lithium-ion battery according to claim 18, wherein the inert gas is one or more selected from a group consisting of argon, helium, neon and nitrogen.

24. The method for preparing a halide-based nanocomposite for a solid electrolyte of a lithium-ion battery according to claim 18, wherein the mixing in solid state is performed by mechanical milling selected from a group consisting of ball milling, vibration milling, turbo milling, mechanofusion and disc milling.

25. The method for preparing a halide-based nanocomposite for a solid electrolyte of a lithium-ion battery according to claim 24, wherein the mechanical milling is performed at 300-800 rpm for 5-30 hours.

26. The method for preparing a halide-based nanocomposite for a solid electrolyte of a lithium-ion battery according to claim 18, wherein
the metal oxide precursor is Li₂O, LiNO₃ or a mixture thereof,
the metal halide precursor is ZrCl₄, ZrBr₄ or a mixture thereof,
the halide-based nanocomposite is prepared by further mixing a lithium halide precursor,
the lithium halide precursor is LiCl, LiBr or a mixture thereof,
the halide-based nanocomposite is represented by Chemical Formula 1 or 3 and, in Chemical Formula 1, the content of M1O_{c} is 7-8 vol % and the content of LiₐM1X_{b} is 92-93 vol %,
in Chemical Formula 3, the content of LiX is 2-25 vol %, the content of M1O_{c} is 5-12 vol % and the content of LiₐM1X_{b} is 66-93 vol %, and
in Chemical Formula 1 or 3, the M1O_{c} is in-situ grown ZrO₂ having an average crystal size of 5-10 nm as observed by TEM analysis.

27. The method for preparing a halide-based nanocomposite for a solid electrolyte of a lithium-ion battery according to claim 26, wherein
the metal oxide precursor is Li₂O, LiNO₃ or a mixture thereof,
the metal halide precursor is ZrCl₄, ZrBr₄ or a mixture thereof,
the halide-based nanocomposite is prepared by further mixing a lithium halide precursor,
the lithium halide precursor is LiCl, LiBr or a mixture thereof,
the inert gas is argon,
the mixing in solid state is performed by mechanical milling selected from ball milling and vibration milling,
the mechanical milling is performed at 500-700 rpm for 7-18 hours,
the halide-based nanocomposite is represented by Chemical Formula 3 and, in Chemical Formula 3, the content of LiX is 2-25 vol %, the content of M1O_{c} is 5-12 vol % and the content of LiₐM1X_{b} is 66-93 vol %,
in Chemical Formula 3, the M1O_{c} is in-situ grown ZrO₂ having an average crystal size of 5-10 nm as observed by TEM analysis,
the in-situ grown ZrO₂ is formed in the form of a net formed in the LiₐM1X_{b} host of Chemical Formula 3,
the halide-based nanocomposite is 1.26LiCl-0.44ZrO₂-0.56Li₂ZrCl₆ or 0.11LiCl-0.27ZrO₂-0.73Li₂ZrCl₆, and
the halide-based nanocomposite has an ion conductivity of 1.17-2 mS/cm at 30° C.

28. The method for preparing a halide-based nanocomposite for a solid electrolyte of a lithium-ion battery according to claim 27, wherein
the metal oxide precursor is Li₂O,
the metal halide precursor is ZrCl₄,
the halide-based nanocomposite is prepared by further mixing a lithium halide precursor,
the lithium halide precursor is LiCl,
the inert gas is argon,
the mixing in solid state is performed by mechanical milling which is ball milling,
the mechanical milling is performed at 580-620 rpm for 9-11 hours,
the halide-based nanocomposite is represented by Chemical Formula 3 and, in Chemical Formula 3, the content of LiX is 2-25 vol %, the content of M1O_{c} is 5-12 vol % and the content of LiₐM1X_{b} is 66-93 vol %,
in Chemical Formula 3, the M1O_{c} is in-situ grown ZrO₂ having an average crystal size of 5-10 nm as observed by TEM analysis,
the in-situ grown ZrO₂ is formed in the form of a net formed in the LiₐM1X_{b} host of Chemical Formula 3,
the halide-based nanocomposite is 1.26LiCl-0.44ZrO₂-0.56Li₂ZrCl₆,
the halide-based nanocomposite has an ion conductivity of 1.28-1.33 mS/cm at 30° C., and
the halide-based nanocomposite exhibits a first effective peak and a second effective peak at 0.4-0.6 ppm and −0.2 to 0.2 ppm, respectively, in ⁶Li MAS NMR analysis, and the intensity ratio of the first effective peak to the second effective peak is 0.7-0.8.
